(19) United States
(12) Patent Application Publication
(10) Pub. No.: US 2010/0309514 A1
(43) Pub. Date: Dec. 9, 2010

(54) PRINTER, PRINTER SYSTEM, PRINTING CONTROL METHOD, AND COMPUTER-READABLE RECORDING MEDIUM HAVING RECORDED THEREON PRINTING CONTROL PROGRAM

(75) Inventor: Daisuke TANAKA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/791,196

(22) Filed: Jun. 1, 2010

(30) Foreign Application Priority Data
Jun. 4, 2009 (JP) 2009-135037

(51) Int. Cl. G06F 15/00

(52) U.S. Cl. 358/1.15

(57) ABSTRACT

A printer includes a communication unit that receives print data via a communication circuit, an environmental information detection unit that detects environmental information indicative of an environmental state at printing, a determination unit that determines whether printing is possible based on the environmental information detected by the environmental information detection unit and a printing unit that executes printing on a print sheet based on the print data received by the communication unit, upon the determination unit determining that printing is possible.

### CROSS-REFERENCE TO RELATED APPLICATIONS

This application is based upon and claims the benefit of priority of the prior Japanese Patent Application No. 2009-135037, filed on Jun. 4, 2009, the entire contents of which are incorporated herein by reference.

### FIELD

Various embodiments discussed herein relate to a printer, a printer system and a method thereof including for controlling the printer.

### BACKGROUND

Various methods have been proposed as countermeasures against a sheet jam of a printer. For example, a manufacturer requires users to use all print sheets that are set in a feeding cassette of a printer, within a specified period of time as much as possible in order to prevent moisture absorption of the print sheets. In addition, an environmental sensor that detects the temperature, the humidity, and the like of a printer, is installed in the printer. An appropriate printing speed and the like are controlled referring to the temperature, the humidity, and the like, which are detected by the environmental sensor, thereby preventing curling or a jam of a print sheet from occurring at printing. As another example using an environmental sensor, there is a method in which previous printing conditions, previous environmental conditions, and a history of occurrence of a sheet jam for each attribute of print sheets, are recorded. In this method, it is determined whether or not the temperature, the humidity, and the like at printing newly executed are similar to the history of occurrence. If the temperature, the humidity, and the like are similar to the history of occurrence, the printing is cancelled to prevent occurrence of a sheet jam (e.g., Japanese Unexamined Patent Application Publication No. 2006-297654).

### SUMMARY

According to an aspect of the invention, a printer includes, a communication unit that receives print data via a communication circuit, an environmental information detection unit that detects environmental information indicative of an environmental state at printing, a determination unit that determines whether printing is possible based on the environmental information detected by the environmental information detection unit and a printing unit that executes printing on a print sheet based on the print data received by the communication unit, upon the determination unit determining that printing is possible.

An object and advantages of the invention will be realized and attained by means of the elements and combinations particularly pointed out in the claims.

It is to be understood that both the foregoing general description and the following detailed description are exemplary and explanatory and are not restrictive of the invention, as claimed. Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a printer according to an embodiment;

FIG. 2 illustrates a printer system according to an embodiment;

FIG. 3 is a configuration diagram of a printer according to an embodiment;

FIG. 4 illustrates a hardware configuration of the printer according to an embodiment;

FIG. 5 is a block diagram showing a configuration of the printer according to an embodiment;

FIG. 6 is a flowchart showing a procedure of a printing execution process according to an embodiment;

FIG. 7 is a flowchart showing the procedure of the printing execution process according to an embodiment;

FIG. 8 is a flowchart showing the procedure of the printing execution process according to an embodiment;

FIG. 9 is a flowchart showing the procedure of the printing execution process according to an embodiment;

FIG. 10 illustrates one example of a setting screen of a printing execution process;

FIG. 11 illustrates one example of a data structure of threshold information;

FIG. 12 illustrates one example of an alarm output screen at a double-side printing process; and

FIG. 13 illustrates one example of an alarm output screen at a single-side printing process.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

The following will describe embodiments with reference to the accompanying drawings.

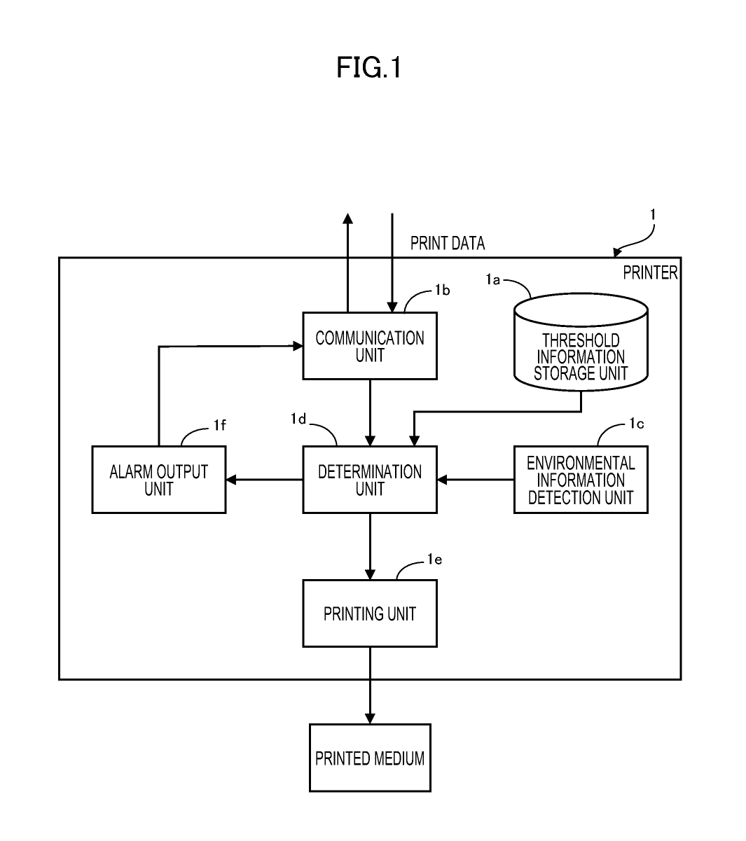

FIG. 1 illustrates a printer according to an embodiment.

A printer 1 shown in FIG. 1 receives print data from an information processing apparatus (not shown) connected thereto via a communication circuit, and executes printing on a print sheet that is set in the printer. It is noted that a user can perform an operation input with respect to the printer 1 and receive a notice from the printer 1, via the information processing apparatus. The printer 1, which executes process(es) such printing, includes a threshold information storage unit 1a, a communication unit 1b, an environmental information detection unit 1c, a determination unit 1d, a printing unit 1e, and an alarm output unit 1f. It is noted that the processing function of each processing unit of the printer 1 may be implemented by a computer executing a printing control program.

The threshold information storage unit 1a has stored therein threshold information that is indicative of threshold(s) for environmental information at which printing is impossible. It is noted that the environmental information is indicative of an environmental state, and, specifically, includes data pertaining to the temperature and the humidity of the printer 1, and a leave time period for which print sheets that are set in the printer 1 are left, at a time when printing is to be executed by the printer 1. Further, for each print sheet that is set in the printer 1, a moisture absorption amount suitable for printing changes in response to the environmental information. Such threshold information includes, for example, an impossible temperature, an impossible humidity, and a predetermined time period, at which print sheets curl. While particular examples of environmental information as the threshold information are described herein, the present invention is not limited to any particular information as the threshold information and may include data of any element that has effect on operation of the printer 1.

In other words, if environmental information at printing falls within ranges of the impossible temperature, the impossible humidity, and the predetermined time period, which are stored in the threshold information storage unit 1a, the moisture absorption amounts of print sheets increase, and the print sheets curl. Thus, when printing is executed on the curled print sheet, a sheet jam occurs in the printer 1. It is noted that the threshold information stored in the threshold information storage unit 1a is previously set by the user.

The communication unit 1b receives print data that is transmitted from the information processing apparatus via the communication circuit. In addition, the communication unit 1b transmits, to the information processing apparatus via the communication circuit, an alarm output instruction that is from the later-described alarm output unit 1f and indicates that printing is impossible.

The environmental information detection unit 1c is disposed, for example, in the printer 1, and detects the environmental information such as the temperature and the humidity of the printer 1, the leave time period of the print sheets, and the like at printing. The determination unit 1d compares the threshold information stored in the threshold information storage unit 1a with the temperature and the humidity of the printer 1 and the leave time period of the print sheets, which are detected by the environmental information detection unit 1c. The determination unit 1d determines whether or not printing is possible on the print sheets that are set in the printer 1, on the basis of the comparison. In addition, when determining that printing is possible, the determination unit 1d transmits a printing instruction command to the later-described printing unit 1e. On the other hand, when determining that printing is impossible, the determination unit 1d transmits an alarm output instruction to the later-described alarm output unit 1f.

Upon receipt of the printing instruction command from the determination unit 1d, the printing unit 1e executes printing on the set print sheet on the basis of the print data received by the communication unit 1b, to output a printed medium. Upon receipt of the alarm output instruction from the determination unit 1d, the alarm output unit 1f notifies the communication unit 1b of the effect that printing is impossible.

Next, a printing execution process in the printer 1 having the above configuration will be described with reference to FIG. 1. First, the user sets thresholds for environmental information on print sheets that are set in the printer 1, via the information processing apparatus. It is noted that, as the threshold information, an impossible temperature, an impossible humidity, and a predetermined time period, at which print sheets curl, are set as described above. In addition, the set threshold information may be received by the communication unit 1b, and stored in the threshold information storage unit 1a of the printer 1.

Print data for printing content such as a predetermined text or image is transmitted by the user to the printer 1 via the information processing apparatus. After the communication unit 1b receives the print data, the environmental information detection unit 1c detects the environmental information of the printer 1. As described above, the environmental information includes the temperature, the humidity, and the leave time period of the print sheets that are set in the printer 1, at the time when printing is to be executed by the printer 1.

The determination unit 1d compares the threshold information stored in the threshold information storage unit 1a with the temperature and the humidity of the printer 1 and the leave time period of the print sheets, which are detected by the environmental information detection unit 1c. For example, if the leave time period of the print sheets, which is detected by the environmental information detection unit 1c, is not within a predetermined time period stored in the threshold information storage unit 1a, the moisture absorption amount of each print sheet that is set in the printer 1 is large. Thus, when printing is executed in this state, the print sheets curl. In addition, if the temperature and the humidity of the printer 1, which are detected by the environmental information detection unit 1c, respectively fall within the ranges of the impossible temperature and the impossible humidity that are stored in the threshold information storage unit 1a as well, the print sheets curl. If the above both cases are satisfied, there is a high possibility that a sheet jam will occur in the printer 1.

The determination unit 1d executes such comparison, and determines whether or not printing is possible on the print sheets that are set in the printer 1. When printing is possible, the determination unit 1d gives the printing instruction command to the printing unit 1e. On the other hand, when printing is impossible, the determination unit 1d gives the alarm output instruction to the alarm output unit 1f.

The printing unit 1e receives the printing instruction command from the determination unit 1d, and executes printing on the set print sheet on the basis of the content of the print data, to output a printed medium. On the other hand, the alarm output unit if receives the alarm output instruction from the determination unit 1d, and notifies the information processing apparatus, connected via the communication circuit, of the effect that printing is impossible. The user can recognize that printing is impossible, via the information processing apparatus, and can perform handling such as cancellation of printing, or exchange of the print sheets.

By such a printer 1, occurrence of curling of the print sheets that are set in the printer 1 is expected. Thus, it is possible to in advance prevent a jam of the print sheet from occurring in the printer 1 at printing.

The following will describe the printer and the printing execution process in the printer, by using, as an example, a printer system having such a printer.

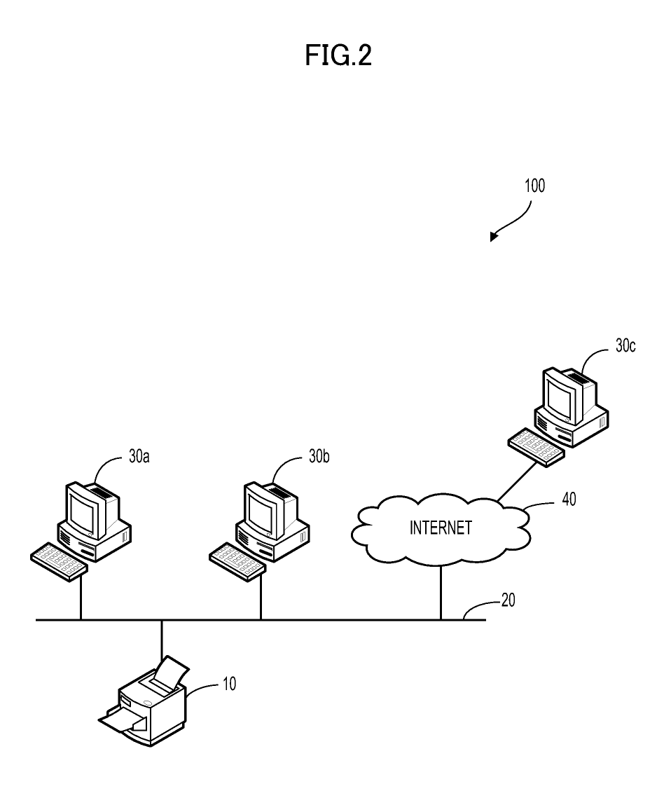

FIG. 2 illustrates a printer system according to an embodiment.

In a printer system 100 shown in FIG. 2, a printer 10 and personal computers 30a, 30b and 30c (30a to 30c) are connected to each other via a network 20. Each of the personal computers 30a to 30c is a host terminal that transmits thresholds for environmental information, print data, and a printing instruction. It is assumed that the personal computers 30a to 30c are used by different users, respectively. Further, each of the users of the personal computers 30a to 30c shares the printer 10, as a network printer, via the network 20 such as a LAN (local area network). It is noted that the personal computer 30c shares the printer 10 via the Internet 40. When requesting printing of a text, an image, or the like, each user operates the respective personal computer to cause the printer 10 to execute printing. At that time, print data indicative of content, such as text data and image data, is transmitted from the personal computer operated by the user to the printer 10 via the network 20, together with a printing request.

Upon receipt of the print data transmitted via the network 20, the printer 10 executes printing on a print sheet that is set in the printer 10, on the basis of the print data. Thus, the print content requested by the user, such as the text, is printed on the print sheet.

The printer system 100 according to an embodiment includes the single printer 10. However, the number of printers is not limited to that, and the printer system 100 may include a plurality of printers. In addition, the printer system 100 according to an embodiment includes the personal computers 30a to 30c. However, the number of personal computes is not limited to that, and may be one or two, or may be four or more.

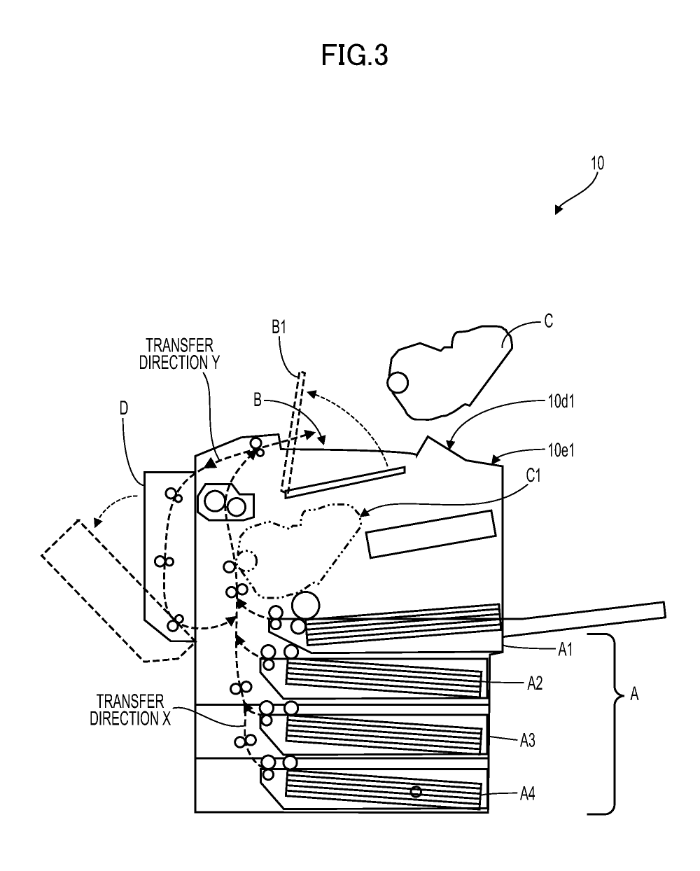

The printer 10 that executes printing in such a printer system 100 will be described in detail. FIG. 3 is a configuration diagram of a printer according to an embodiment.

The printer 10 shown in FIG. 3 executes printing on a print sheet on the basis of print data indicative of content such as text data and image data. The printer 10 includes a sheet feeding unit A in which print sheets are set, a sheet discharge unit B to which a printed print sheet is discharged, a cartridge C, and a double-side unit D. Further, the printer 10 includes a display panel 10d1 for displaying information such as characters, and an operation unit 10e1 for receiving an operation input of the user.

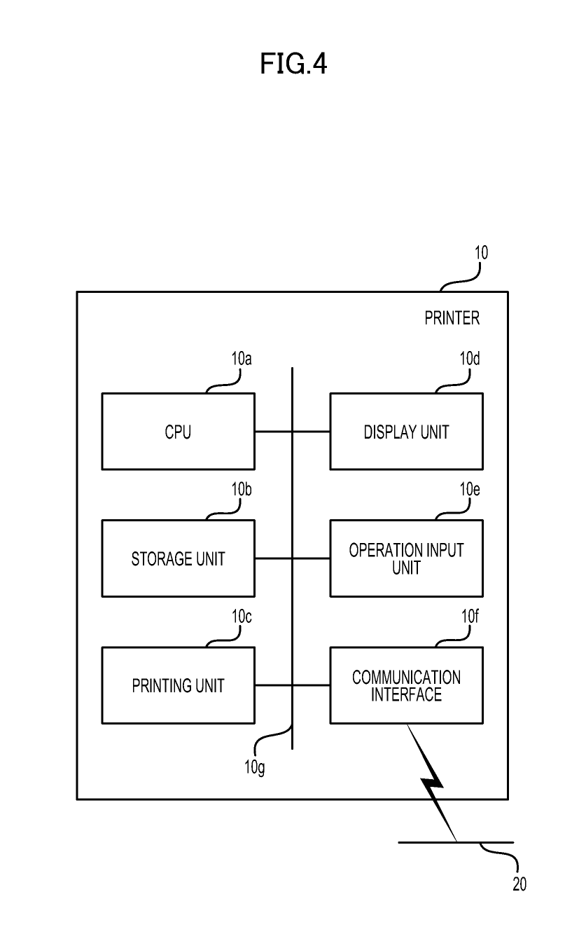

In the sheet feeding unit A, sheet feeding cassettes A1 to A4 are detachably mounted, in which print sheets are set by sheet size. When a sheet jam occurs in the printer 10, the corresponding sheet feeding cassette is detached, and the print sheet remaining in the printer 10 can be removed. It is noted that print sheets of the same size may be set in the sheet feeding cassettes A1 to A4. In addition, the number of sheet feeding cassettes is not limited to four, but may be one to three, or may be five or more. A print sheet that is set in such a sheet feeding unit A is transferred by a transfer mechanism in the printer 10, subjected to printing by a printing unit 10c (described in detail below with reference to FIG. 4), and discharged from the sheet discharge unit B.

The sheet discharge unit B is a mechanism from which the print sheet subjected to printing by the printing unit 10c (described below in detail with reference to FIG. 4) is discharged. The sheet discharge unit B has a cover B1. The cartridge C is detachably installed in a portion where the cover B1 is opened.

The cartridge C is filled with a developer and installed at an installation position C1 in the printer 10 shown in FIG. 3, and the cover B1 is closed. The cartridge C installed thus is exposed on a transfer path through which a print sheet is transferred in a transfer direction X, and comes into contact with a printing-out unit (not shown) for printing out on a print sheet, to supply the developer to the printing-out unit.

The double-side unit D is used when double-side printing is executed by the printer 10. First, a print sheet transferred from either sheet feeding cassette of the sheet feeding unit A is transferred along the transfer direction X and subjected to printing. When transferred just before the sheet discharge unit B, the printed print sheet is transferred along a transfer direction Y to the double-side unit D so that a rear of the print sheet (with respect to the transfer direction X) reaches the double-side unit D first, and then transferred again to the printing-out unit in which the cartridge C is installed. At that time, the back side of the print sheet comes into contact with the printing-out unit and is subjected to printing. After the printing, the print sheet is transferred along the transfer direction X to the sheet discharge unit B. In this manner, the double-side unit D can circulate the print sheet therein, so that printing can be executed on the back side of the print sheet.

Moreover, the display panel 10d1 is a display having a display screen for displaying characters or an image under the control of a display unit 10d (described below in detail with reference to FIG. 4). The operation unit 10e1 is an input device that is connected to an operation input unit 10e (described below in detail with reference to FIG. 4) and is for performing an operation of the printer 10. It is noted that a device to which the display panel 10d1 and the operation unit 10e1 are combined, namely, a touch panel, may be used. Further, the display panel 10d1 and the operation unit 10e1 may not be installed, and settings and the like of the printer 10 may be executed via the personal computer.

Moreover, a sensor (not shown) that detects the temperature and the humidity of the printer 10 is installed in the printer 10. Similarly, a position detection device (not shown) that detects the installation position of the printer 10, such as a GPS (global positioning system), is installed in the printer 10.

An embodiment has described the printer 10. However, the invention is not limited thereto, and any apparatus other than a printer may be used as long as it has a printing function. For example, a multifunctional printer having the functions of a printer, a FAX machine, a copying machine, and the like, may be used.

FIG. 4 illustrates a hardware configuration of the printer according to an embodiment. The printer 10 shown in FIG. 4 is controlled entirely by a CPU (central processing unit) 10a. A storage unit 10b, a printing unit 10c, a display unit 10d, an operation input unit 10e, and a communication interface 10f are connected to the CPU 10a via a bus 10g. In addition, the sensor that detects the temperature and the humidity of the printer 10 and is installed in the printer 10, and the position detection device that detects the installation position of the printer 10 and is installed in the printer 10, are connected to the CPU 10a. Further, a timer having a clock function is connected to the CPU 10a. The timer also has a calendar function, and information on: year; month; date; and time are previously inputted therein at factory shipment. Thus, the current date and time can be known.

The storage unit 10b includes a RAM (random access memory), a ROM (read only memory), a hard disk drive (HDD), and the like. A program and data required for controlling the printer 10 and executing printing, and at least a part of print data, are stored in the storage unit 10b. For example, control of the printer 10 is executed by: developing printer firmware stored in the ROM into the RAM by the CPU 10a; and executing the program on the RAM. In addition, setting information and the like unique to the printer 10 are stored in the ROM, and developed into the RAM when the printer 10 is started up.

The printing unit 10c executes printing on the basis of the print data under the control of the CPU 10a. The display panel 10d1 (FIG. 3) is connected to the display unit 10d. The display unit 10d displays an image on the screen of the display panel 10d1 in accordance with an instruction from the CPU 10a.

The operation unit 10e1 (FIG. 3) is connected to the operation input unit 10e. The operation input unit 10e transmits a signal transmitted from the operation unit 10e1, to the CPU 10a via the bus 10g.

The communication interface 10f is connected to the network 20. The communication interface 10f transmits or receives data to or from the personal computer via the network 20.

It is noted that, in the case where the display panel 10d1 and the operation unit 10e1 are not installed, the configuration of the display unit 10d and the operation input unit 10e can be omitted. By the above hardware configuration, the processing functions according to an embodiment can be implemented.

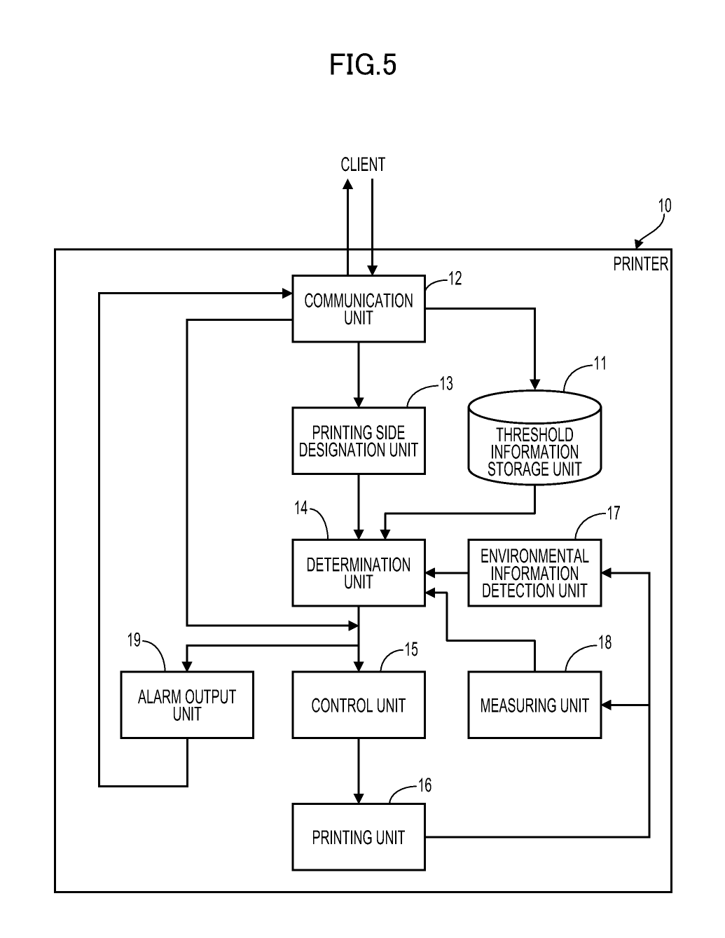

FIG. 5 is a block diagram showing a configuration of the printer 10 according to an embodiment. The printer 10 shown in FIG. 5 receives print data and the like from the personal computers 30a to 30c connected thereto via the network 20 (FIG. 2), and executes printing.

The printer 10 includes a threshold information storage unit 11, a communication unit 12, a printing side designation unit 13, a determination unit 14, a control unit 15, a printing unit 16, an environmental information detection unit 17, a measuring unit 18, and an alarm output unit 19. It is noted that the printer 10 operates as the printer 1 in FIG. 1. Thus, the threshold information storage unit 11, the communication unit 12, and the determination unit 14 implement the processing functions of the threshold information storage unit 1a, the communication unit 1b, and the determination unit 1d, respectively. Further, the environmental information detection unit 17 and the measuring unit 18 implement the processing function of the environmental information detection unit 1c, the alarm output unit 19 implements the processing function of the alarm output unit 1f, and the control unit 15 and the printing unit 16 implement the processing function of the printing unit 1e.

Threshold information indicative of thresholds for environmental information is stored in the threshold information storage unit 11. The environmental information, for example, includes the temperature and the humidity of the printing unit 16 in the printer 10, and a leave time period for which each print sheet that is set in the sheet feeding unit A of the printer 10 is left. Further, the environmental information according to an embodiment also includes date and the installation position of the printer 10. As the threshold information, a double-side impossible temperature, a double-side impossible humidity, a single-side impossible temperature, a single-side impossible humidity, and a predetermined time period, at which print sheets curl, are set. In addition, as the threshold information, an exclusion period and an exclusion area that are respectively indicative of a period and an area in which print sheets are unlikely to curl, are set. Specifically, the exclusion period is a period in which the moisture absorption amount of a print sheet is relatively small, for example, the period of from November to February in Japan. Similarly, the exclusion area is an area in which the moisture absorption amount of a print sheet is relatively small, for example, a predetermined dry area. The threshold information can be configured to be previously set by the user via the personal computer in accordance with the material of print sheets to be used, and the like.

The communication unit 12 obtains print data transmitted from the personal computer via the network 20, and receives control data for controlling execution of printing, the threshold information indicative of the thresholds for the environmental information, and other data. In addition, the communication unit 12 stores the received threshold information in the threshold information storage unit 11. It is noted that the print data is indicative of content to be printed on a print sheet, such as text data and image data. The control data is indicative of the size of print sheets, the number of sheets to be printed, and printing side (double-side or single-side) for the sheets. Further, the communication unit 12 transmits alarm data from the later-described alarm output unit 19, to the personal computer via the network 20.

The printing side designation unit 13 designates printing side for the print sheets on which print data is to be printed, in accordance with the control data received by the communication unit 12. The determination unit 14 compares the threshold information stored in the threshold information storage unit 11 with the temperature, the humidity, and the installation position of the printer 10 that are detected by the later-described environmental information detection unit 17. Further, the determination unit 14 compares the threshold information with the current date and time and the leave time period of the print sheets that is measured by the measuring unit 18. The determination unit 14 determines whether or not printing is possible on the print sheets on the basis of the comparison.

It is noted that, for the current date and time, instead of the timer described with reference to FIG. 4, the clock function can be implemented in the printer 10 by installing a protocol for time setting such as the NTP (Network Time Protocol: RFC1305, 1769, and the like) protocol, even when the hardware timer is not installed. Further, each personal computer generally has a clock function, and the current date and time are set therein. When print data is transmitted from the personal computer to the printer 10, information on the current date and time that are set in the personal computer is transmitted to the printer 10 together with the print data. Then, when the print data is received by the printer 10, the current date and time can be easily recognized by referring to the date-time information in the print data.

When the determination unit 14 determines that printing is possible, or in accordance with the control data received by the communication unit 12, the control unit 15 transmits a printing instruction signal based on the control data, to the printing unit 16.

Upon receipt of the printing instruction signal from the control unit 15, the printing unit 16 executes printing on the print sheet that is set in the sheet feeding unit A, on the basis of the print data and the control data that are received by the communication unit 12.

The environmental information detection unit 17 detects the temperature and the humidity of the printing unit 16 in the printer 10 at printing, and the installation position of the printer 10. The measuring unit 18 measures the leave time period of each print sheet that is set in the sheet feeding unit A of the printer 10. A specific example of the method of measuring a leave time period will be described. First, after the printer 10 is turned on to be ready for printing, the printer 10 starts monitoring an open-close state of the sheet feeding unit A. When the open-close state of a sheet feeding cassette is changed from “open” to “close” during the monitoring, the printer 10 determines that the print sheets in the sheet feeding cassette are exchanged. Then, an elapsed time from the time of the determination is counted up as a leave time period for the sheet feeding cassette. The counted leave time period is used as environmental information. In another example, a detection device that is capable of detecting: whether or not there are any print sheets in each sheet feeding cassette; and a remaining amount of print sheets, is installed in the printer 10. In addition to the presence/absence and the remaining amount of print sheets that are detected by the detection device, a detection result of the above open-close state is used in combination, whereby it is possible to highly accurately determine exchange of print sheets. As a method other than detection of the open-close state of the sheet feeding cassette, a time that elapses from the time when printing is executed last may be measured.

When the determination unit 14 determines that printing is impossible, the alarm output unit 19 notifies the personal computer, via the communication unit 12, of the effect that printing is impossible on the print sheets that are set in the sheet feeding unit A. In addition, the alarm output unit 19 is capable of causing the personal computer to output a screen for selecting a subsequent print process.

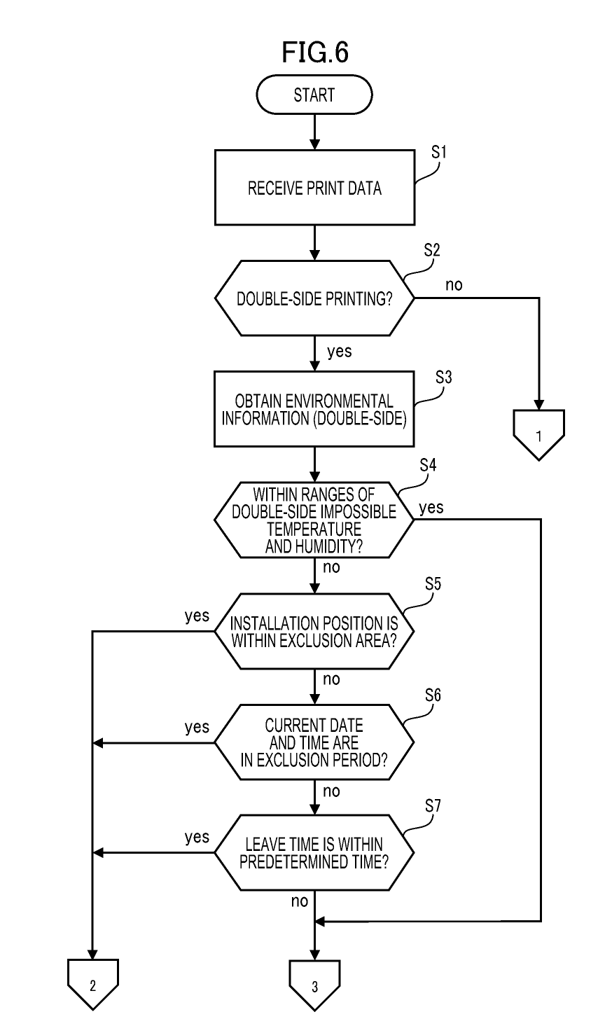

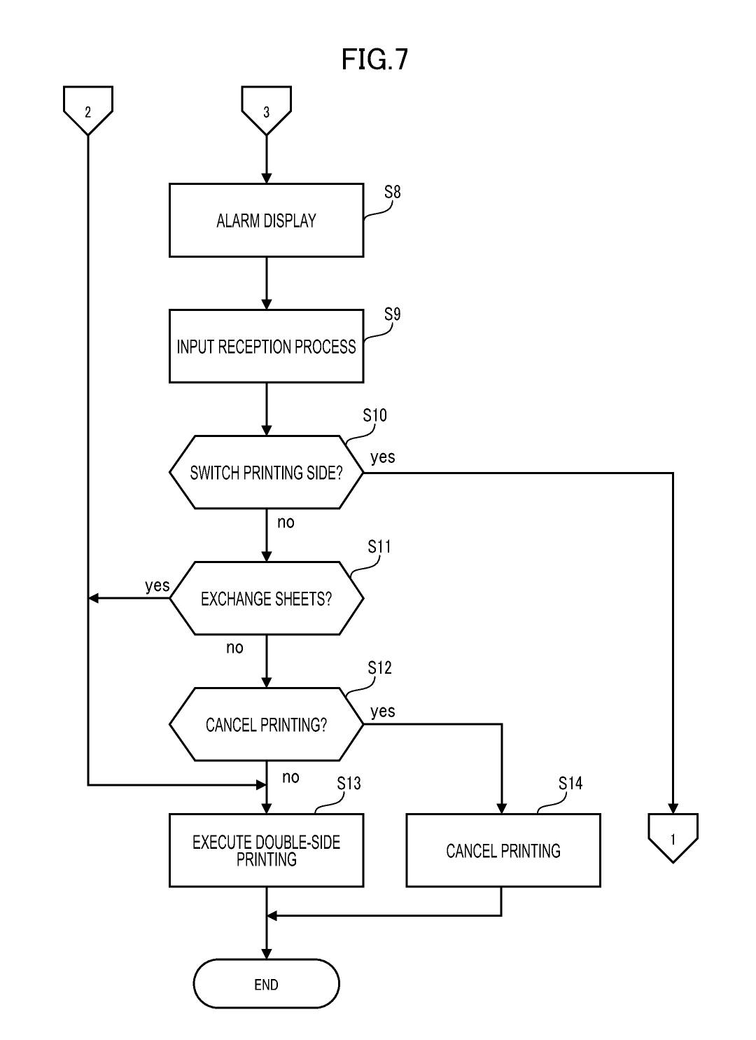

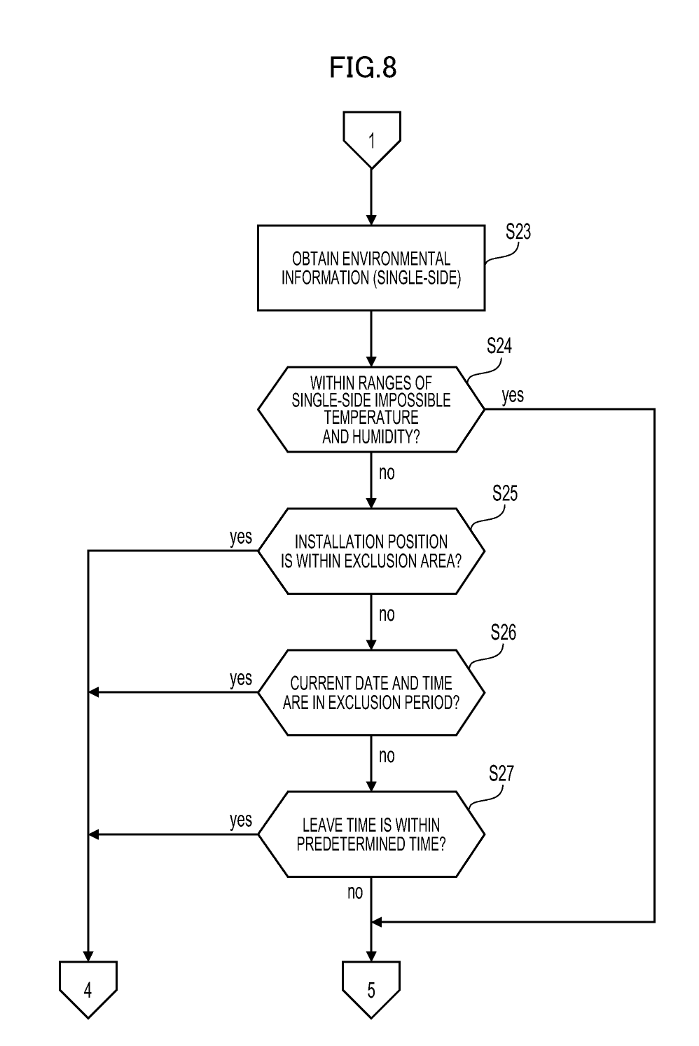

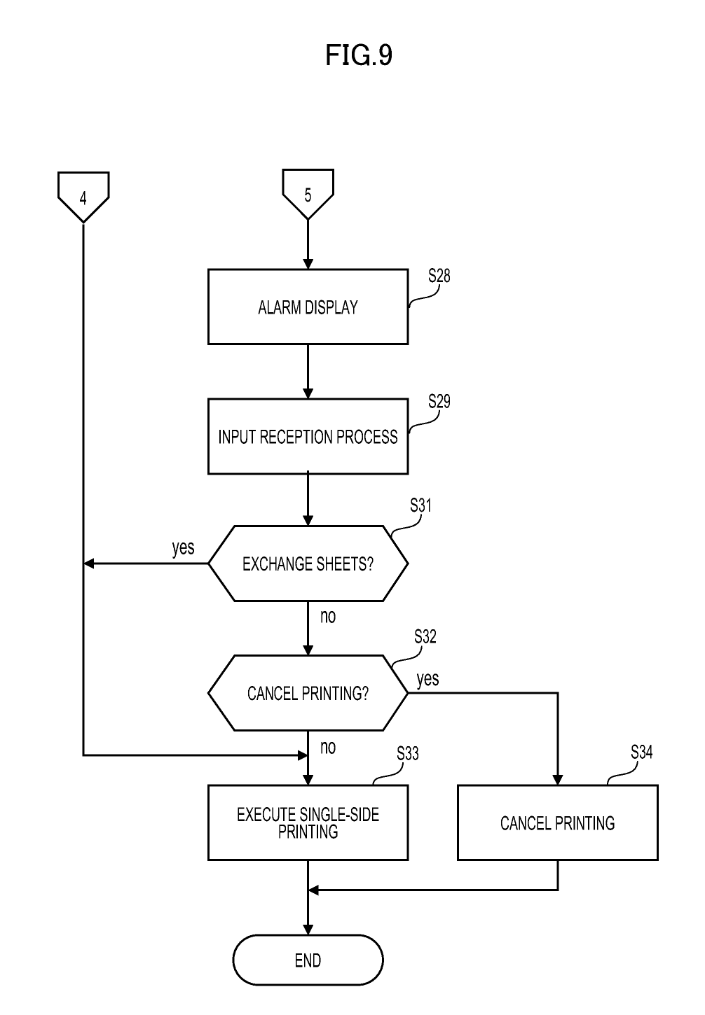

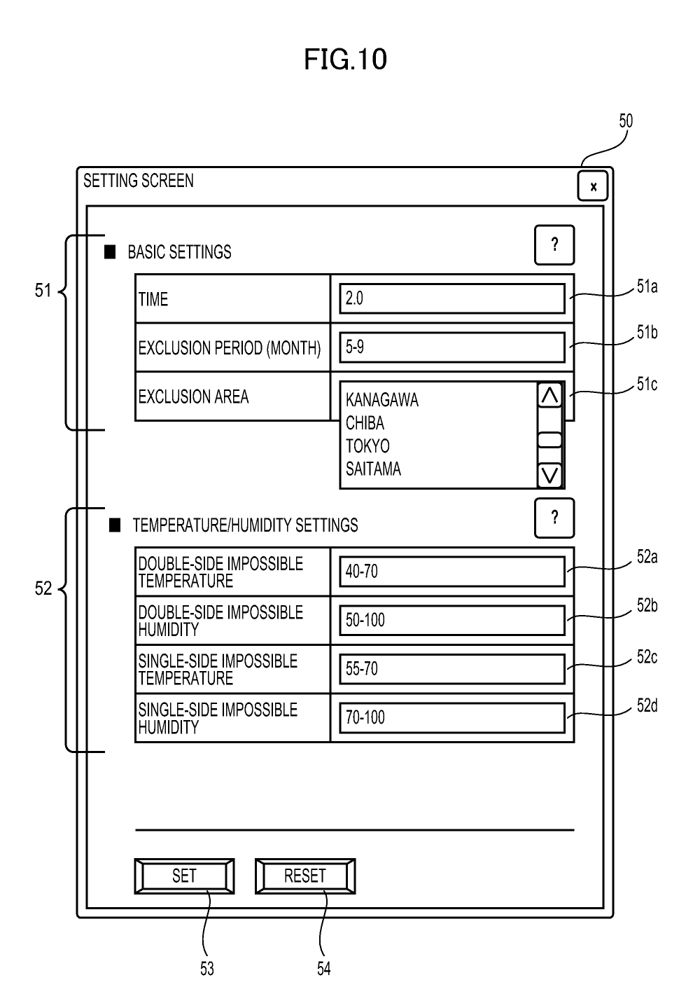

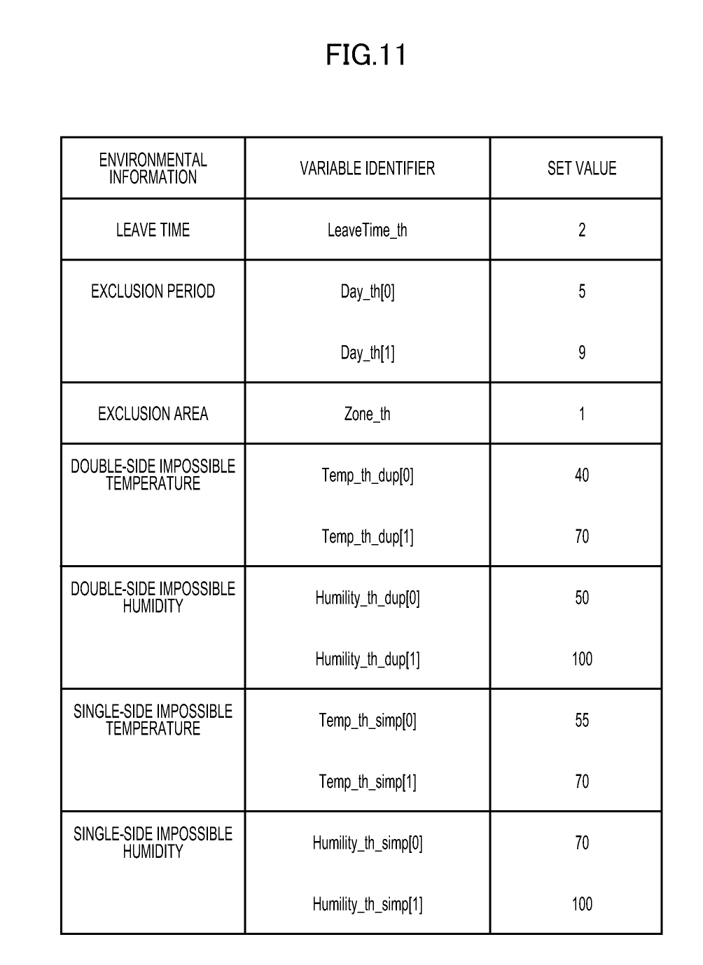

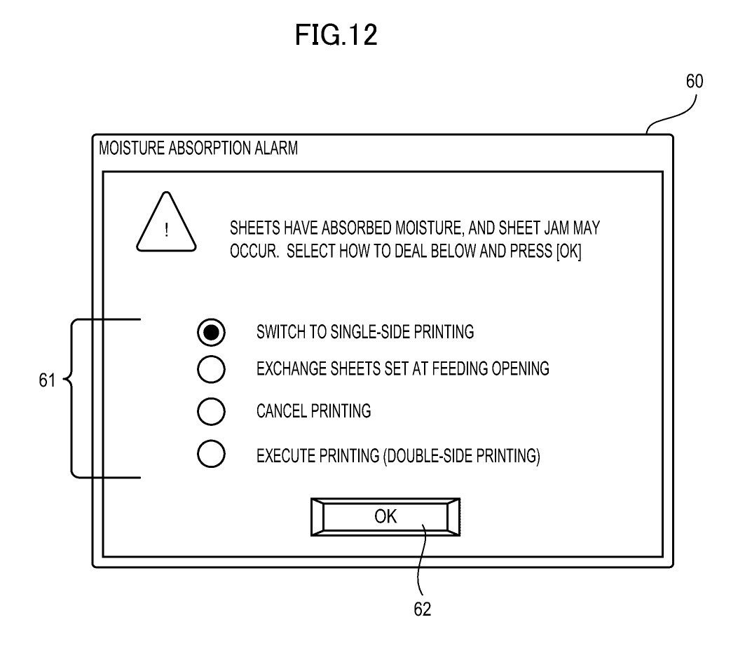

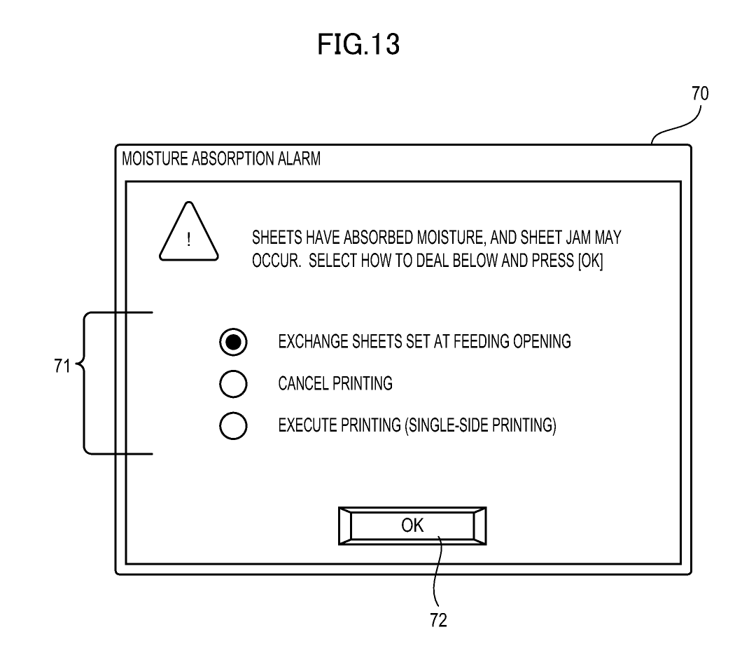

The following will describe a printing execution process executed in an embodiment. FIGS. 6 to 9 are flowcharts showing a procedure of the printing execution process according to an embodiment. FIG. 10 illustrates one example of a setting screen of the printing execution process, and FIG. 11 illustrates one example of a data structure of the threshold information. Further, FIGS. 12 and 13 each illustrate one example of an alarm output screen at a double-side or single-side printing process.

The printing execution process shown in FIGS. 6 to 9 is executed on the printer 10. In the printing execution process, the printer 10 executes printing on the basis of the print data and the control data that are transmitted from the personal computer via the network 20 (FIG. 2).

First, the user operates the personal computer to input and set a double-side impossible temperature, a double-side impossible humidity, a single-side impossible temperature, a single-side impossible humidity, a predetermined time period, at which print sheets curl. Further, the user similarly sets an exclusion period and an exclusion area in which print sheets are unlikely to curl. While specific examples of the user input information is illustrated herein, the present invention is not limited thereto.

For example, with respect to a setting screen 50 displayed on the display screen of the personal computer as shown in FIG. 10, the user can input and set thresholds for the environmental information. In a basic setting region 51, a predetermined time period (indicated as “time” in FIG. 10), an exclusion period, and an exclusion area, are inputted into a leave time period setting region 51a, an exclusion period setting region 51b, and an exclusion area setting region 51c, respectively. As illustrated with the setting screen in FIG. 10, any of the settings can be adjusted or changed as desired including by an input of the user.

Further, in a temperature-humidity setting region 52, a double-side impossible temperature, a double-side impossible humidity, a single-side impossible temperature, and a single-side impossible humidity are inputted into a double-side impossible temperature setting region 52a, a double-side impossible humidity setting region 52b, a single-side impossible temperature setting region 52c, and a single-side impossible humidity setting region 52d, respectively.

In order to fix the threshold information inputted into each setting region, the user clicks a setting button 53 on the screen. Further, in order to clear the inputted threshold information, the user similarly clicks a reset button 54.

The thresholds for the environmental information, which are set thus, are received by the communication unit 12 from the personal computer, and the communication unit 12 stores, in the threshold information storage unit 11, threshold information indicative of these received thresholds for the environmental information.

For each item of the threshold information stored in the threshold information storage unit 11, for example, a variable identifier and set value(s) are set as shown in FIG. 11. After such initial setting is completed, the user transmits a printing instruction to the printer 10. The printer 10 starts execution of print processing on the basis of: the print data such as text data; and the control data.

The communication unit 12 receives the print data and the control data transmitted via the personal computer by the user. As described above, the print data is indicative of content to be printed on a print sheet, such as text data and image data. Further, the control data is indicative of the size of print sheets, a sheet feeding cassette, the number of sheets to be printed, and printing side (double-side or single-side) for the sheets, which are designated by the user.

The printing side designation unit 13 designates printing side for the print sheets in accordance with the control data received by the communication unit 12. When the designated printing side is double-side, the processing proceeds to Operation S3. When the designated printing side is not double-side, namely, when the designated printing side is single-side, the processing proceeds to Operation S23.

The environmental information detection unit 17 obtains the temperature and the humidity of the printing unit 16 in the printer 10, the installation position of the printer 10, and the current date and time. Further, the measuring unit 18 measures a leave time period of the print sheets that are set in the sheet feeding unit A of the printer 10.

The determination unit 14 determines whether or not the temperature and the humidity of the printing unit 16 in the printer 10 that are obtained at Operation S3 respectively fall within ranges of the double-side impossible temperature and the double-side impossible humidity that are stored in the threshold information storage unit 11. When the temperature and the humidity respectively fall within the ranges, the processing proceeds to Operation S8. When the temperature and the humidity do not respectively fall within the ranges, the processing proceeds to Operation S5.

The determination unit 14 determines whether or not the installation position of the printer 10 that is obtained at Operation S3 falls within the exclusion area stored in the threshold information storage unit 11. When the installation position falls within the exclusion area, the processing proceeds to Operation S13. When the installation position does not fall within the exclusion area, the processing proceeds to Operation S6.

The determination unit 14 determines whether or not the current date and time at printing that are obtained at Operation S3 fall within the exclusion period stored in the threshold information storage unit 11. When the current date and time fall within the exclusion period, the processing proceeds to Operation S13. When the current date and time do not fall within the exclusion period, the processing proceeds to Operation S7.

The determination unit 14 determines whether or not the leave time period of the print sheets that are set in the printer 10, which leave time period is obtained at Operation S3, falls within the predetermined time period stored in the threshold information storage unit 11. When the leave time period falls within the predetermined time period, the processing proceed to Operation S13. When the leave time period does not fall within the predetermined time period, the processing proceed to Operation S8.

The alarm output unit 19 outputs, from the communication unit 12 to the personal computer, a result that printing is impossible. Further, the alarm output unit 19 causes the personal computer to display a screen for selecting a subsequent print process. The print process to be selected include “switch to single-side printing”, “exchange print sheets”, “cancel printing”, and “execute double-side printing”, they are displayed, and the personal computer receives a result of selection made by the user.

For example, a possibility of occurrence of a sheet jam is alarmed as in an alarm output screen 60 shown in FIG. 12, and the screen for selecting a subsequent print process is displayed in a print process selection region 61. The user selects a desired print process from the print process selection region 61, and clicks an OK button 62 on the screen to fix the print process.

The communication unit 12 receives, from the user, the result of the selection of the print process that is made after it is determined that printing is impossible. It is noted that, the selectable print processes in an embodiment are “switch to single-side printing”, “exchange print sheets”, “cancel printing”, and “execute double-side printing” as described at Operation S8.

When the communication unit 12 receives, from the user, an instruction to switch printing side to single-side printing, the processing proceeds to Operation S23. When the communication unit 12 receives another instruction, the processing proceeds to Operation S11.

When the communication unit 12 receives, from the user, an instruction to exchange print sheets, the processing proceeds to Operation S13. When the communication unit 12 receives another instruction, the processing proceeds to Operation S12.

When the communication unit 12 receives, from the user, an instruction to cancel printing, the processing proceeds to Operation S14. When the communication unit 12 receives another instruction, namely, when the communication unit 12 receives an instruction to continue double-side printing, the processing proceeds to Operation S13.

The control unit 15 causes the printing unit 16 to execute printing on the both sides of the print sheet on the basis of the print data, and the printing execution process ends.

When the user selects an instruction to exchange print sheets (Operation S11), the control unit 15 stops the print processing once. Then, when the measuring unit 18 detects that the open-close state of the sheet feeding cassette is changed from “close” through “open” to “close”, it is determined that the print sheets in the sheet feeding cassette are replaced with new sheets that have not absorbed moisture, and the control unit 15 restarts printing of the printing unit 16.

The control unit 15 cancels printing of the printing unit 16 on the print sheet, and the printing execution process ends.

The environmental information detection unit 17 obtains again the temperature and the humidity of the printing unit 16 in the printer 10 and the installation position of the printer 10.

The determination unit 14 determines whether or not the temperature and the humidity of the printing unit 16 in the printer 10 that are obtained at Operation S23 respectively fall within ranges of the single-side impossible temperature and the single-side impossible humidity that are stored in the threshold information storage unit 11. When the temperature and the humidity respectively fall within the ranges, the processing proceeds to Operation S28. When the temperature and the humidity do not respectively fall within the ranges, the processing proceeds to Operation S25.

The determination unit 14 determines whether or not the installation position of the printer 10 that is obtained at Operation S23 falls within the exclusion area stored in the threshold information storage unit 11. When the installation position falls within the exclusion area, the proceeding proceeds to Operation S33. When the installation position does not fall within the exclusion area, the proceeding proceeds to Operation S26.

The determination unit 14 determines whether or not the current date and time at printing that is obtained at Operation S3 falls within the exclusion period stored in the threshold information storage unit 11. When the current date and time fall within the exclusion period, the processing proceeds to Operation S33. When the current date and time do not fall within the exclusion period, the processing proceeds to Operation S27.

The determination unit 14 determines whether or not the leave time period of the print sheets that are set in the printer 10, which leave time period is obtained at Operation S3, falls within the predetermined time period stored in the threshold information storage unit 11. When the leave time period falls within the predetermined time period, the processing proceeds to Operation S33. When the leave time period does not fall within the predetermined time period, the processing proceeds to Operation S28.

The alarm output unit 19 outputs, from the communication unit 12 to the personal computer, a result that printing is impossible. Further, the alarm output unit 19 causes the personal computer to display a screen for selecting a subsequent print process. The print process to be selected includes “exchange print sheets”, “cancel printing”, and “execute single-side printing”, they are displayed, and the personal computer receives a result of selection made by the user.

For example, a possibility of occurrence of a sheet jam is alarmed as in an alarm output screen 70 shown in FIG. 13, and the screen for selecting a subsequent print process is displayed in a print process selection region 71. The user selects a desired print process from the print process selection region 71, and clicks an OK button 72 on the screen to fix the print process.

The communication unit 12 receives, from the user, the result of the selection of the print process that is made after it is determined that printing is impossible. It is noted that, the selectable print processes in an embodiment are “exchange print sheets”, “cancel printing”, and “execute single-side printing” as described at Operation S28.

When the communication unit 12 receives, from the user, an instruction to exchange print sheets, the processing proceeds to Operation S33. When the communication unit 12 receives another instruction, the processing proceeds to Operation S32.

When the communication unit 12 receives, from the user, an instruction to cancel printing, the processing proceeds to Operation S34. When the communication unit 12 receives another instruction, namely, when the communication unit 12 receives an instruction to continue single-side printing, the processing proceeds to Operation S33.

The control unit 15 causes the printing unit 16 to execute printing on a single side of the print sheet on the basis of the print data, and the printing execution process ends.

When the user selects an instruction to exchange print sheets (Operation S31), the control unit 15 stops the print processing once. Then, when the measuring unit 18 detects that the open-close state of the sheet feeding cassette is changed from “close” through “open” to “close”, it is determined that the print sheets in the sheet feeding cassette are replaced with new sheets that have not absorbed moisture, and the control unit 15 restarts printing of the printing unit 16.

The control unit 15 cancels printing of the printing unit 16 on the print sheet, and the printing execution process ends.

In the above printing execution process, occurrence of curling of the print sheets is determined by comparing the previously set thresholds, at which print sheets curl, with the environmental information of the printer 10 at printing. In particular, the accuracy of the result of the determination as to occurrence of print sheet curling is improved by taking into consideration the leave time period of the print sheets in the sheet feeding unit A. Thus, execution or cancellation of printing can be selected in accordance with the determination result, and hence it is possible to prevent a jam of a print sheet. Further, a condition of a print request is used to obtain a corresponding environmental information previously set as a threshold for a type of the print request.

The order of the processes at Operations S10 to S12 is not limited to that in the above printing execution process. In addition, similarly, the order of Operations S31 and S32 is not limited to that in the above printing execution process. Further, the subsequent print process to be selected at Operations S8 or S28 may include the following choice. Specifically, print sheets having the same type and size as those of the target print sheets are previously set in another sheet feeding cassette. Then, at alarm output, there may be a choice for selecting the print sheets that are set in the other sheet feeding cassette. When the print sheets that are set in the other sheet feeding cassette are selected, the process from Operation S3 or S13 is started again.

According to an embodiment, a method and a system of controlling a printer is provided. The method includes selectively setting a condition for enabling printing and controlling a printer based on a comparison of a currently sensed condition of the printer with a condition previously set for a type of a print request received. According to another embodiment, a condition set for a printer is adjusted or changed based on an input from a user. Further, one condition may be set for a first print request while another condition may be set for a second print request, as illustrated in FIG. 10 for example.

Each of the above processing functions can be implemented by a computer. In this case, a program is provided which describes processing content of the functions that the printer 1 or 10 should have. The above processing functions are implemented on the computer by executing the program on the computer. The program that describes the processing content can be recorded on a computer-readable recording medium. Examples of the computer-readable recording medium include a magnetic recording device, an optical disc, an optical magnetic recording medium, and a semiconductor memory. Examples of the magnetic recording device include a hard disk drive (HDD), a flexible disk (FD), and a magnetic tape (MT). Examples of the optical disc include a DVD (Digital Versatile Disc), a DVD-RAM, a CD-ROM ROM (Compact Disc Read Only Memory), and a CD-R (Recordable)/RW (ReWritable). Examples of the optical magnetic recording medium include an MO (Magneto-Optical Disk).

In the case of distributing the program, for example, portable recording media each having recorded the program thereon, such as DVD and CD-ROM, are marketed. Further, the program is stored in a storage device of a server computer, and can be transferred from the server computer to another computer via a network.

For example, the computer that executes the printing control program stores, in a storage device thereof, the program recorded on the portable recording medium, or the program transferred from the server computer. Then, the computer reads the program from the storage device thereof, and executes processes in accordance with the program. It is noted that the computer can read the program directly from the portable recording medium, and can execute processes in accordance with the program. Further, the computer can sequentially receive the program every time the program is transferred from the server computer, and can execute processes in accordance with the sequentially received program.

As mentioned above, the embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. A printer, comprising:
a communication unit that receives print data via a communication circuit;
an environmental information detection unit that detects environmental information indicative of an environmental state at printing;
a determination unit that determines whether printing is possible based on the environmental information detected by the environmental information detection unit; and
a printing unit that executes printing on a print sheet based on the print data received by the communication unit, upon the determination unit determining that printing is possible.

2. The printer according to claim 1, wherein the determination unit determines whether a moisture absorption amount of the print sheet is suitable for printing based on the environmental information.

3. The printer according to claim 1, wherein the environmental information includes a leave time period of the print sheet from a time when the print sheet is set to a time when printing is newly executed.

4. The printer according to claim 1, wherein the environmental information includes a leave time period of the print sheet from a time when printing is executed last to a time when printing is newly executed.

5. The printer according to claim 1, comprising:
a threshold information storage unit that stores threshold information indicative of the environmental information at which printing is impossible, and
wherein the determination unit determines whether printing is possible based on the threshold information stored in the threshold information storage unit and the environmental information detected by the environmental information detection unit.

6. The printer according to claim 5, wherein the environmental information includes temperature information indicative of a temperature at printing, and
the threshold information includes impossible temperature information indicative of a temperature at which printing is impossible.

7. The printer according to claim 5, wherein the environmental information includes humidity information indicative of a humidity at printing, and
the threshold information includes impossible humidity information indicative of a humidity at which printing is impossible.

8. The printer according to claim 5, wherein the environmental information includes date-time information indicative of a date and a time at printing, and
the threshold information includes period information indicative of a period in which printing is possible.

9. The printer according to claim 8, wherein a moisture absorption amount of the print sheet in the period is suitable for printing.

10. The printer according to claim 5, wherein the environmental information includes position information on an installation position of the printer, and
the threshold information includes area information indicative of an area in which printing is possible.

11. The printer according to claim 10, wherein a moisture absorption amount of the print sheet in the area is suitable for printing.

12. The printer according to claim 1, comprising:
an alarm output unit that, when the determination unit determines that printing is impossible, causes the communication unit to notify an external that printing is impossible.

13. A printer system, comprising:
an information processing apparatus; and
a printer, and
the information processing apparatus including:
a transmission unit that transmits print data,
the printer including:
a communication unit that receives the print data from the information processing apparatus via a communication circuit;
an environmental information detection unit that detects an environmental information indicative of an environmental state at printing;
a determination unit that determines whether printing is possible based on the environmental information detected by the environmental information detection unit; and
a printing unit that executes printing on a print sheet based on the print data when the determination unit determines that printing is possible.

14. A printing control method, comprising:
receiving print data via a communication circuit;
detecting environmental information indicative of an environmental state at printing;
determining whether printing is possible based on the detected environmental information; and
executing printing on print sheet based on the print data when determining that printing is possible.

15. The printing control method according to claim 14, comprising:
determining whether a moisture absorption amount of the print sheet is suitable for printing based on the environmental information.

16. The printing control method according to claim 14, wherein the environmental information includes a leave time period of the print sheet from a time when the print sheet is set to a time when printing is newly executed.

17. The printing control method according to claim 14, wherein the environmental information includes a leave time period of the print sheet from a time when printing is executed last to a time when printing is newly executed.

18. The printing control method according to claim 14, comprising:
storing threshold information indicative of the environmental information at which printing is impossible, and
determining whether printing is possible based on the stored threshold information and the detected environmental information.

19. The printing control method according to claim 14, comprising:
notifying an external that printing is impossible, when determining that printing is impossible.

20. A computer-readable recording medium having recorded thereon a printing control program that is executed by a printer, the printing control program causing the printer to executes a method comprising:
receiving print data via a communication circuit;
detecting environmental information indicative of an environmental state at printing;
determining whether printing is possible based on the detected environmental information;
executing printing on print sheet based on the print data when determining that printing is possible.
